(19) United States
(12) Patent Application Publication
(10) Pub. No.: US 2024/0167694 A1
(43) Pub. Date: May 23, 2024

(54) COOKTOP ASSEMBLY WITH KINESTHETIC FEATURE

(71) Applicant: WHIRLPOOL CORPORATION, BENTON HARBOR, MI (US)

(72) Inventors: Mario Barbati, Comerio (IT); Margherita Basso, Scorzè (IT); Andrea Gallivanoni, Casorate Sempione (IT); Annalisa Pacioni, Bresso (IT)

(73) Assignee: WHIRLPOOL CORPORATION, BENTON HARBOR, MI (US)

(21) Appl. No.: 18/515,825

(22) Filed: Nov. 21, 2023

Related U.S. Application Data
(60) Provisional application No. 63/427,684, filed on Nov. 23, 2022.

(51) Int. Cl. F24C 15/10

(52) U.S. Cl. CPC F24C 15/107; F24C 15/102

(57) ABSTRACT

A cooktop assembly includes a cooking panel. A heating element is operably coupled to the cooking panel. The heating element forms a heating zone for said cooktop assembly. A support surface extends over the heating element for supporting a cooking vessel thereon. The support surface includes a heating zone surface in the heating zone, a surrounding surface outside the heating zone, and a surface discontinuity defining a kinesthetic feature providing feedback for demarcating the heating zone relative to the surrounding surface and positioning the cooking vessel relative to the heating zone and, consequently, the heating element.

### CROSS-REFERENCE TO RELATED APPLICATIONS

This application claims priority to and the benefit under U.S.C. § 119(e) of U.S. Provisional Patent Application No. 63/427,684, filed on Nov. 23, 2022, entitled COOKTOP ASSEMBLY WITH KINESTHETIC FEATURE, the entire disclosure of which is hereby incorporated herein by reference.

### BACKGROUND OF THE DISCLOSURE

The present disclosure generally relates to a cooktop assembly. More specifically, the present disclosure relates to a cooktop assembly including a surface discontinuity defining a kinesthetic feature providing kinesthetic feedback for demarcating a heating zone.

### SUMMARY OF THE DISCLOSURE

According to an aspect of the present disclosure, a cooktop assembly includes a cooking panel. A heating element is operably coupled to the cooking panel. The heating element forms a heating zone for said cooktop assembly. A support surface extends over the heating element for supporting a cooking vessel thereon. The support surface includes a heating zone surface in the heating zone, a surrounding surface outside the heating zone, and a surface discontinuity defining a kinesthetic feature providing feedback for demarcating the heating zone relative to the surrounding surface and positioning the cooking vessel relative to the heating zone and, consequently, the heating element.

According to another aspect of the present disclosure, a cooktop assembly includes a cooking panel, heating elements operably coupled to the cooking panel to define heating zones for the cooktop assembly, and a support surface extending over the heating elements and configured to support cooking vessels thereon. The support surface includes heating zone surfaces aligned with the heating elements and a surrounding surface. The support surface defines a first surface disruption forming a first recessed surface relative to the surrounding surface, the first recessed surface being defined over a first one of the heating elements to provide kinesthetic feedback for a location of a first one of the heating zones to align the cooking vessels with the first one of the heating elements. The support surface defines a second surface disruption forming a second recessed surface relative to the surrounding surface, the second recessed surface being defined over a second one of the heating elements to provide kinesthetic feedback for a location of a second one of the heating zones to align the cooking vessels with the second one of the heating elements.

According to yet another aspect of the present disclosure, a cooktop assembly includes a cooking panel including an upper support surface, the upper support surface including heating zone surfaces and a surrounding surface, and a texture element arranged along the upper support surface. The cooktop assembly includes electric heating elements operably coupled to the cooking panel and aligned with the heating zone surfaces to define heating zones for the cooktop assembly, the heating zones including at least one demarcated heating zone. The texture element defines at least one surface discontinuity providing kinesthetic feedback for demarcating the at least one demarcated heating zone relative to the surrounding surface.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top plan view of a cooktop assembly with grates having a kinesthetic feature arranged over a burner assembly, according to the present disclosure;

FIG. 2 is a side perspective view of grates of a cooktop assembly disposed over burner assemblies, where one grate includes a kinesthetic feature arranged over the corresponding burner assembly, according to the present disclosure;

FIG. 3 is a side perspective view of grates of a cooktop assembly disposed over burner assemblies, where the grates include kinesthetic features arranged over the corresponding burner assemblies, according to the present disclosure;

FIG. 4 is a side perspective view of grates of a cooktop assembly disposed over burner assemblies, where the grates include kinesthetic features arranged over the corresponding burner assemblies, according to the present disclosure;

FIG. 5 is a partial side perspective view of a grate including a kinesthetic feature with multiple levels arranged over a corresponding burner assembly, according to the present disclosure;

FIG. 6A is a schematic side elevational view of a grate including a kinesthetic feature with multiple levels and a cooking vessel disposed on one level of the kinesthetic feature, according to the present disclosure;

FIG. 6B is a schematic side elevational view of the grate of FIG. 6A with the cooking vessel disposed on a second level of the kinesthetic feature, according to the present disclosure;

FIG. 7 is a top plan view of a cooktop assembly with heating zones demarcated with kinesthetic features, according to the present disclosure;

FIG. 8 is a side perspective view of a cooking panel for a cooktop assembly with each heating zone demarcated by kinesthetic features according to the present disclosure;

FIG. 9 is a side perspective view of a cooking panel for a cooktop assembly with each heating zone demarcated by kinesthetic features according to the present disclosure;

FIG. 10 is a partial cross-sectional view of a cooking panel with a first heating zone demarcated by kinesthetic features having a single level and a second heating zone demarcated by a second kinesthetic feature having multiple levels, according to the present disclosure;

FIG. 11 is a partial cross-sectional view of a cooking panel formed of multiple panel layers to define kinesthetic features demarcating heating zones, according to the present disclosure;

FIG. 12 is a top plan view of a cooktop assembly with heating zones being demarcated by a kinesthetic feature, according to the present disclosure;

FIG. 13 is a partial top plan view of a cooktop assembly with heating zones being demarcated by a kinesthetic feature, according to the present disclosure; and

FIG. 14 is a top plan view of a cooktop assembly with heating zones being demarcated by a kinesthetic feature, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooktop assembly with kinesthetic feature. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

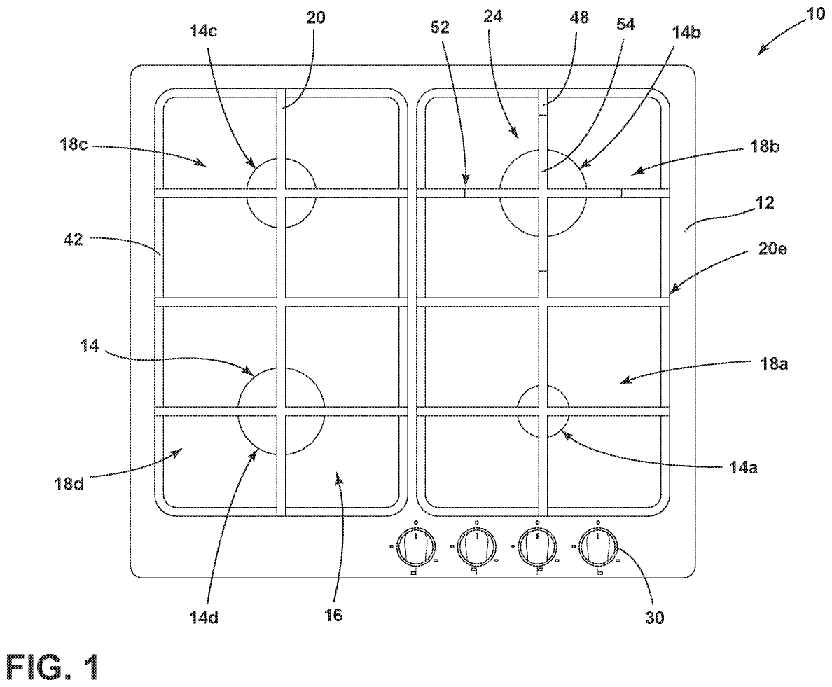

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-14, reference numeral 10 generally designates a cooktop assembly including a cooking panel 12 and heating elements 14, which may include heating elements 14a-14d, operably coupled to the cooking panel 12. The heating elements 14 each form a heating zone 18, generally including heating zones 18a-18d, for the cooktop assembly 10. The cooktop assembly 10 also includes a support surface 20, including heating zone surfaces 20a-20d and a surrounding surface 20e, for supporting a cooking vessel 22 thereon. The heating zone surfaces 20a-20d align with the heating elements 14a-14d to form the heating zones 18a-10d, respectively, while the surrounding surface 20e is generally outside of the heating zones 18a-18d. The support surface 20 extends over the heating elements 14. The support surface 20 includes or defines a surface discontinuity or surface disruption 23 defining a kinesthetic feature 24 for providing kinesthetic feedback, demarcating one or more of the heating zones 18 relative to a remainder of the support surface 20 (e.g., the surrounding surface 20e) for providing kinesthetic feedback for positioning the cooking vessel 22 relative to the heating zones 18 and, consequently, the heating elements 14.

The cooktop assembly 10 includes a cooking region 16 having multiple heating zones 18, which may each align with respective heating elements 14, and the surrounding surface 20e surrounding the heating zones 18. The surrounding surface 20e is generally a non-active surface that is not used for direct heating or cooking food items with the heating elements 14 and is, therefore, not directly aligned with the heating elements 14. Stated differently, the surrounding surface 20e is the non-heating zone portion of the support surface 20. Each heating zone 18 can be demarcated from the surrounding surface 20e of the support surface 20 with an indicator, which may be serigraphy applied to the cooking panel 12 for visual identification of the heating zones 18, and/or the kinesthetic feature 24 for kinesthetic identification and feedback. The kinesthetic feedback may provide haptic, audible, and/or visual identification of the heating zones 18.

In various examples, the cooktop assembly 10 may be included in a cooking appliance, which may be in the form of a range or standalone unit, such as those installed on a countertop. The cooktop assembly 10 may also be included in the cooking appliance with at least one cooking cavity or oven. It is also contemplated that the cooking appliance 10 may be a stand-alone cooking hob. It is further contemplated that the cooktop assembly 10 may be disposed on another appliance and/or a countertop.

In the illustrated configurations, the cooking assemblies 10 are illustrated as having control knobs 30 for controlling functions of the cooktop assemblies 10, such as the heating elements 14. The controls 30 may be, but are not limited to, knobs, buttons, touch sensitive features, sliders, switches, touch screens, or combinations thereof. The controls 30 are illustrated as being included on the cooking panel 12. However, on various cooking appliances, the controls 30 may be included on a body of the cooking appliance and spaced from the cooking panel 12 without departing from the teachings herein.

Referring still to FIGS. 1-4, the cooktop assembly 10 is illustrated as a gas cooktop assembly 10. The cooktop assembly 10 includes gas burner assemblies 40, which include four gas burners 40a-40d (i.e., the heating elements 14a-14d). The various individual burners 40a-40d may collectively be referred to herein as the gas burner assemblies 40 or gas burners 40 unless a specific one of the burners 40a-40d is discussed. The gas burners 40 may be of any practicable type that may be used in combination with a grate 42. In general, the burners 40 may be fuel-burning burners 40 (e.g., those that rely on the combustion of natural or propane gas for the generation of heat). This may include various types of “hybrid” burners 40, which may generate heat by multiple methods, including fuel-burning and/or electric heating.

The cooktop assembly 10 includes the same number of heating zones 18 as heating elements 14. In the illustrated example, the cooktop assembly 10 has four heating zones 18a-18d with the heating elements 14 configured as the gas burners 40a-40d. As used herein, the various heating zones 18a-18d of the multi-heating zone arrangement may be collectively referred to herein as the heating zones 18, unless a specific one of the heating zones 18a-18d is discussed. The cooking assembly 10 is not limited to the illustrated configuration and may be configured as having any number of heating elements 14 with the same number of heating zones 18 (e.g., a single heating element 14 with one heating zone 18, six heating elements 14 with six heating zones 18, etc.). It is also contemplated that the cooktop assembly 10 may include more heating zones 18 than heating elements 14 (e.g., a single heating element 14 with multiple heating zones 18, four heating elements 14 with five heating zones 18, etc.), or more heating elements 14 than heating zones 18 (e.g., two heating elements 14 with a single heating zone 18, five heating elements 14 with four heating zones 18, etc.).

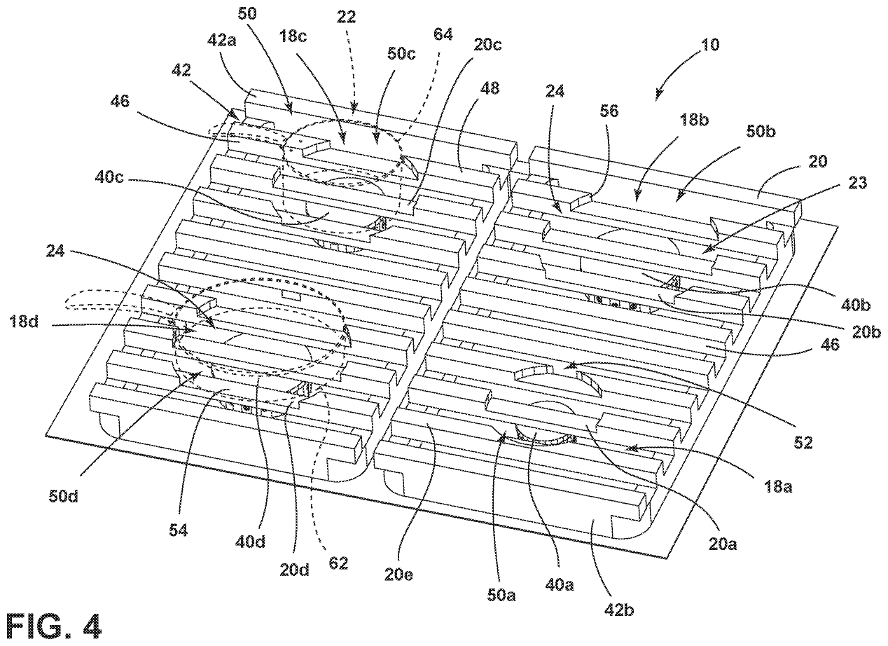

In the example illustrated in FIGS. 1-4, the cooking region 16 of the cooktop assembly 10 includes the grates 42 arranged proximate to one another and over at least one gas burner 40, respectively. The cooktop assembly 10 generally includes two grates 42a, 42b, which may collectively be referred to herein as the grates 42. The grates 42 may include intersecting supports 44, such as the configuration illustrated in FIGS. 1-3, or parallel supports 46, such as the configuration illustrated in FIG. 4. In non-limiting aspects, the grates 42 may be configured as wire grates 42, cast iron grates 42, or any practicable grates 42 for supporting cooking vessels 22 over heating elements 14.

In the illustrated configurations, each grate 42 extends over two gas burners 40, with the left two burners 40c, 40d under one grate 42a and the right two burners 40a, 40b under the second grate 42b. However, other configurations of the grates 42 and burners 40 may be used without departing from the teachings herein. For example, it is contemplated that the cooking region 16 could be defined by a single grate 42 or more than two grates 42. In various aspects, the rear gas burners 40b, 40c may be disposed under the same grate 42a, and the front gas burners 40a, 40d may be disposed under the second grate 42b. In another non-limiting example, a single grate 42 may be used to extend over all four burners 40. Further, four grates 42 may be used, such that each gas burner 40 is disposed under a respective grate 42. Moreover, it is also contemplated that the cooktop assembly 10 may have a single burner 40 or may have two or more burners 40.

The cooking panel 12 supports the grates 42 and defines apertures for the burner assemblies 40. The grates 42 are positioned on the cooking panel 12 and extend over the burners 40. The grates 42 are configured to support cooking vessels 22, such as pans, pots, or the like, above and/or spaced apart from the respective gas burner 40 and the cooking panel 12. Each grate 42 includes or defines the support surface 20 for the cooking vessels 22, including the heating zone surfaces 20a-20d and the surrounding surfaces 20e (e.g., including an upper face 48 formed by the surface discontinuity 23) to support the cooking vessel 22.

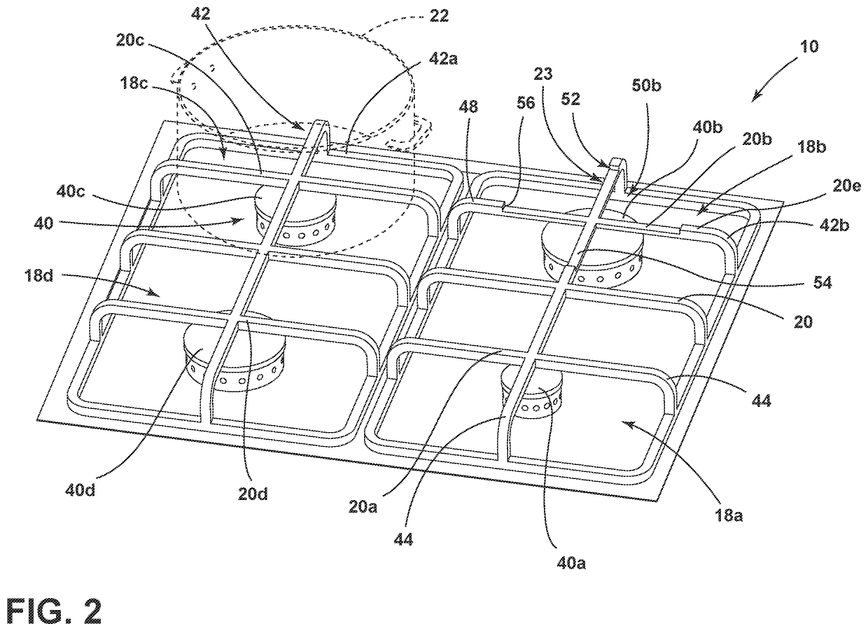

Referring still to FIGS. 1 and 2, one of the heating zones 18b is demarcated from the surrounding surface 20e using the kinesthetic feature 24 for identification and location. Both the heating zone 18b and the surrounding surface 20e of the grate 42 (e.g., outside the heating zone 18b) form the support surface 20 for supporting the cooking vessel 22. The kinesthetic feature 24 is the surface discontinuity 23 defined by the grate 42, separating the heating zone surface 20b from the surrounding surface 20e. More particularly, as illustrated, the kinesthetic feature 24 is configured as a recessed area 50 in the grate 42, defining the heating zone 18b and aligned with the respective gas burner 40b. The recessed area 50 demarcates the support surface 20 within the heating zone 18b (i.e., the heating zone surface 20b) from the remainder of the support surface 20 (i.e., the surrounding surface 20e), which includes the other heating zones 18a, 18c, 18d and the surrounding surface 20e. Accordingly, the heating zone surface 20b is recessed relative to the remaining heating zone surfaces 20a, 20c, 20d, which are continuous and/or co-planar with the surrounding surface 20e.

The support surface 20 defines the kinesthetic feature 24 offset from the remainder of the support surface 20. The recessed area 50 is defined by a plurality of steps 52 in the grate 42, with one or two steps 52 in each intersecting support 44 to form one or more levels for supporting the cooking vessel 22. The recessed area 50 is generally defined where at least two supports 44 intersect to support the cooking vessel 22. With the steps 52, the grate 42 with the surface discontinuity 23 includes a lower face 54 (e.g., the heating zone surface 20b), a step face 56, and the upper face 48 (e.g., the surrounding surface 20e). The lower face 54 and the upper face 48 each form portions of the support surface 20 of the grate 42, with the lower face 54 being part of the recessed area 50 and the upper face 48 being part of the surrounding surface 20e, and with the step face 56 extending generally vertically therebetween to vertically offset the two portions of the support surface 20. The lower face 54 may include or be part of the heating zone surface 20b, and the upper face 48 may include or be part of the remaining heating zone surfaces 20a, 20c, 20d.

In the example illustrated in FIGS. 1 and 2, certain intersecting points of the supports 44 form the heating zones 18, with the supports 44 that form one of the intersecting points defining the steps 52 to form the recessed area 50. Generally, a size of the lower face 54 (e.g., length along the respective support 44) is substantially similar between the supports 44 defining the same recessed area 50. This forms a symmetrical and centered receiving space for the cooking vessels 22 over the respective burner 40. The lower face 54 is generally a single, continuous, planar surface defined by the intersecting supports 44 on which the cooking vessel 22 can be placed. Accordingly, the lower face 54 across the intersecting supports 44 for each demarcated heating zone 18 is a single recessed distance from the surrounding surface 20e of the grates 42. The grates 42 define the recessed areas 50 in the supports 44 (or supports 46 as in FIG. 4) and, therefore, generally do not have a continuous surface over the entire grate 42 for supporting the cooking vessel 22. However, the lower surface 54 may be a continuous surface within the recessed areas 50 of the supports 44.

The steps 52 are configured to provide kinesthetic feedback to a user for locating the heating zone 18, and consequently, the corresponding heating element 14 while using the cooking vessel 22. The surface discontinuity 23 (e.g., the steps 52) providing the kinesthetic feedback may be a single step between the lower face 54 and the upper face 48. In this way, the user receives a kinesthetic response to determine or confirm the position of the cooking vessel 22 over the heating element 14. For instance, the user can slide the cooking vessel 22 across the grate 42, which is generally the upper face 48 of the grate 42 and part of the support surface 20. The user can continue to slide the cooking vessel 22 along the support surface 20 until the cooking vessel 22 drops into or is positioned in the recessed area 50 demarcating the heating zone 18. The steps 52 also provide kinesthetic feedback for centering the cooking vessel 22 relative to the underlying burner 40. By using the step faces 56, the user can determine the boundaries of the heating zones 18 to center the cooking vessel 22 over the heating element 14. The step faces 56 may also be used by the user to assist in straightening or seating the cooking vessel 22 (i.e., not crooked or tilted) within the recessed area 50. The step faces 56 can also ensure a proper sized cooking vessel 22 is being used with a proper sized burner 40 (i.e., the cooking vessel 22 is not too big or too small for the burner 40).

More particularly, if the cooking vessel 22 is smaller than the recessed area 50, the user can slide the cooking vessel 22 along the lower face 54 (e.g., a portion of the support surface 20) of the grate 42 until the cooking vessel 22 engages at least one of the step faces 56. The user can utilize the step faces 56 to determine an approximate center within the recessed area 50 to provide more direct alignment with the gas burner 40. Further, for cooking vessels 22 larger than the recessed area 50, the cooking vessel 22 may still be supported by the upper face 48 of the grate 42, spaced from the lower face 54 in the recessed area 50. The user may utilize the steps 52 to center the larger cooking vessel 62 over the recessed area 50 and, consequently, the gas burner 40.

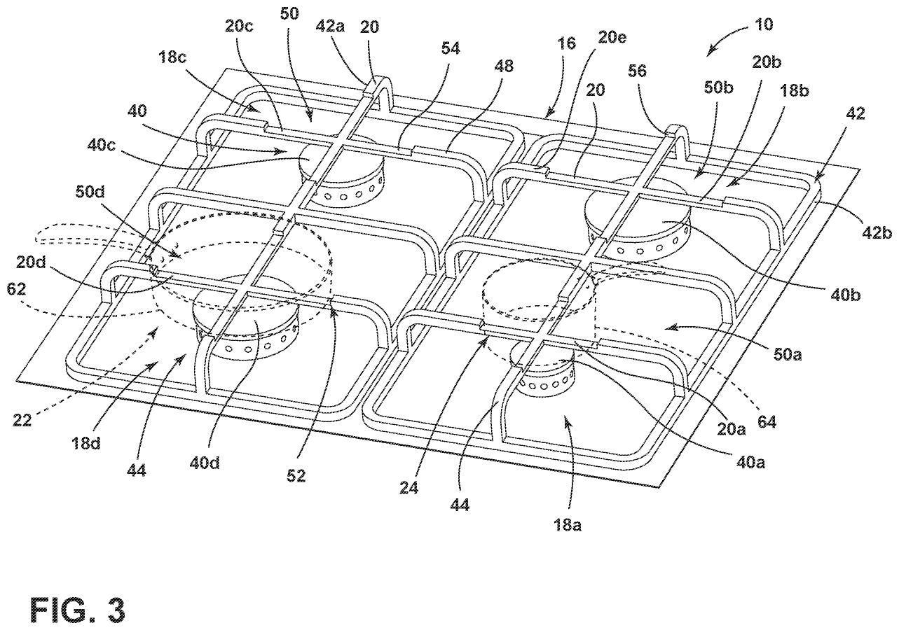

Referring again to FIG. 3, the cooktop assembly 10 includes multiple kinesthetic features 24, where each of the heating zones 18a-18d are defined with the recessed area 50a-50d. It is also contemplated that some of the heating zones 18a-18d are demarcated from the surrounding surface 20e. As used herein, the various recessed areas 50a-50d of the grates 42 may be collectively referred to herein as the recessed areas 50, unless a specific one of the recessed area 50a-50d is discussed. Similar to the recessed area 50 discussed above, the recessed areas 50a-50d are generally defined by the steps 52, which provide kinesthetic feedback to a user for locating the heating zone 18a-18d. The grate 42 includes the lower faces 54 (e.g., the heating zone surfaces 20a-20d), the step faces 56, and the upper face 48 (e.g., the surrounding surface 20e) defining the steps 52. The steps 52 demarcate each of the heating zones 18a-18d from the surrounding surface 20e. The lower faces 54 are each generally a single, continuous, planar surface defined by the intersecting supports 44 on which the cooking vessel 22 can be placed. Accordingly, the lower faces 54 across the intersecting supports 44 for each of the demarcated heating zones 18a-18d are a single recessed distance or depth from the surrounding surface 20e of the grates 42. Each of the lower faces 54 for each of the demarcated heating zones 18a-18d may be recessed at a different or same distance or depth from the surrounding surface 20e of the grates 42.

The size of the recessed areas 50 may be varied. For example, in the illustrated configuration of FIG. 3, each recessed area 50 is a different size, forming different sizes of the lower face 54 for each heating zone 18. In various aspects, some of the recessed areas 50 may be the same or substantially similar in size. The different sizes of the recessed areas 50 may be advantageous for identifying different gas burners 40.

The size of the recessed areas 50 may be correlated to the size or strength of the gas burners 40. For example, the recessed area 50d is the largest recessed area 50, meaning the gas burner 40d is the strongest relative to the other burners 40. The size or strength of the burner 40 may generally correspond with a size of the flame produced by the gas burner 40. In the illustrated configuration, the recessed area 50a is the smallest recessed area 50, meaning the gas burner 40a is the weakest relative to the other gas burners 40.

When using the cooktop assembly 10 of FIG. 3, a large cooking vessel 62 (e.g., one of cooking vessels 22) may be configured to be received in less than all of the recessed areas 50. For example, the large cooking vessel 62 may be received in the heating zone 18d, which has the largest recessed area 50. The user is able to slide a large cooking vessel 62 along the support surface 20 of the grate 42 about the cooking region 16 until the large cooking vessel 62 drops into the recessed area 50d, which identifies the heating zone 18d as the optimal heating zone 18 since the cooking vessel 22 may not drop into the other recessed areas 50a-50c. The optimal heating zone 18 for the large cooking vessel 62 may generally be the largest gas burner 40. The cooking vessel 22 may be used with the other gas burners 40a-40c by being positioned on the upper faces 48 of the respective grate 42 over the recessed areas 50a-50c.

The user is also able to slide a small cooking vessel 64 about the cooking region 16 until the small cooking vessel 64 drops into one of the recessed areas 50. The user can identify the heating zone 18 based on the relative degree of freedom when moving the small cooking vessel 64 about the recessed area 50. If the user has a large degree of freedom in movement before engaging the step faces 56, indicating an outer limit of the recessed area 50, the user can determine the small cooking vessel 64 is in one of the larger recessed areas 50, such as the recessed area 50d. If the user has some degree of freedom in movement, the user can determine the small cooking vessel 64 is in one of the mid-sized recessed areas 50b, 50c. If the user has a small or minimal degree of freedom in movement, the user can determine the small cooking vessel 64 is in the smallest recessed area 50a. The user is able to identify the optimal heating zone 18 for the size of the cooking vessel 22 by identifying the heating zone 18 through the movement of the cooking vessel 22 along the support surface 20 of the grate 42, including the upper and lower faces 48, 54.

The user is not limited to using the cooking vessel 22 in the recessed areas 50. In this way, the user may place larger cooking vessels 22 on the upper face 48 of the grates 42 over the smaller recessed areas 50a-50c. The user can also use the small cooking vessel 64 in the larger recessed areas 50b-50d without departing from the teachings herein. The recessed areas 50 provide kinesthetic feedback, through haptic, audible, and/or visual feedback, for positioning the cooking vessels 22 over the gas burners 40. Further, the kinesthetic features 24 provide feedback for centering the cooking vessels 22 over the heating elements 14.

Referring to FIG. 4, the grates 42 are formed by the parallel supports 46 defining the support surface 20. The grates 42 may be a cast iron grate or any parallel support grate 42. The grates 42 include the kinesthetic features 24 configured as the steps 52 to define the recessed areas 50, which generally form a single level below the surrounding surface 20e for supporting the cooking vessels 22. Multiple adjacent supports 46 include the steps 52 to form the recessed areas 50. The step faces 56 may be angled or curved across supports 46 to form circular recessed areas 50. The lower face 54 on adjacent parallel supports 46 are different in both shape and size, particularly when the overall recessed area 50 forms a circular shape, as in the illustrated configuration. Each recessed area 50 is generally co-planar and defined by the lower faces 54 on each of the adjacent parallel supports 46. Stated differently, each recessed area 50 is formed by a plurality of co-planar lower faces 54 where each of the co-planar lower faces 54 are defined in a respective parallel support 46. Each recessed area 50 is generally formed from three adjacent parallel supports 46 but more or fewer parallel supports 46 may be used depending on the size and shape of the recessed area 50 and the size and shape of the parallel supports 46. The size of the recessed areas 50 may be correlated to the size or strength of the gas burners 40, similar to the configuration in FIG. 3. For example, the recessed area 50a is the smallest recessed area 50, meaning the gas burner 40a is the weakest relative to the other gas burners 40.

When using the cooktop assembly 10 of FIG. 4, the large cooking vessel 62 can be received in less than all of the recessed areas 50. The user is able to slide the large cooking vessel 62 along the support surface 20 of the grate 42 in a similar manner discussed in reference to FIG. 3. The user would also be able to slide the small cooking vessel 64 about the cooking region 16 until the small cooking vessel 64 drops into one of the recessed areas 50. The user would be able to determine the size of the recessed area 50 in a similar manner discussed in reference to FIG. 3. The user would also be able to determine the optimal heating zone 18 for the size of the cooking vessel 22 by identifying the heating zone 18 through the movement of the cooking vessel 22 along the support surface 20 of the grate 42, including the upper and lower faces 48, 54. Moreover, the kinesthetic features 24 provide feedback for centering the cooking vessels 22 over the heating elements 14.

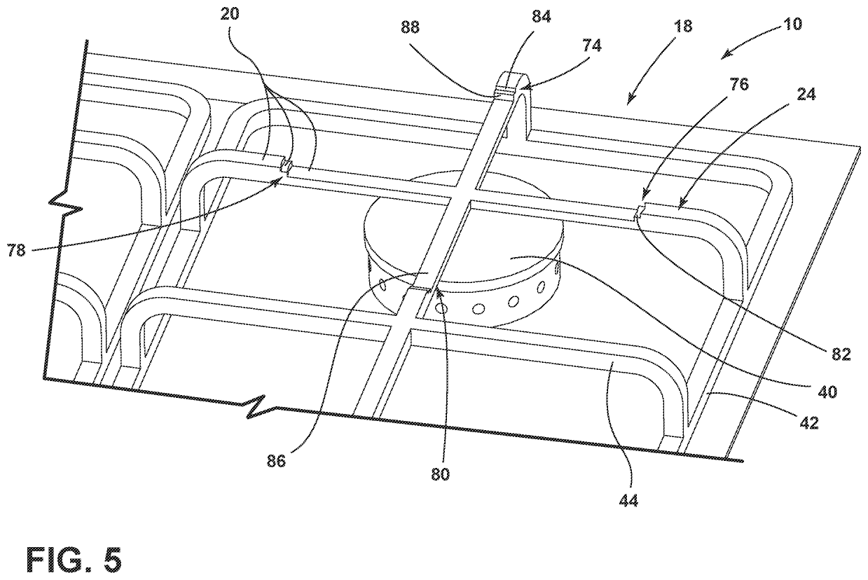

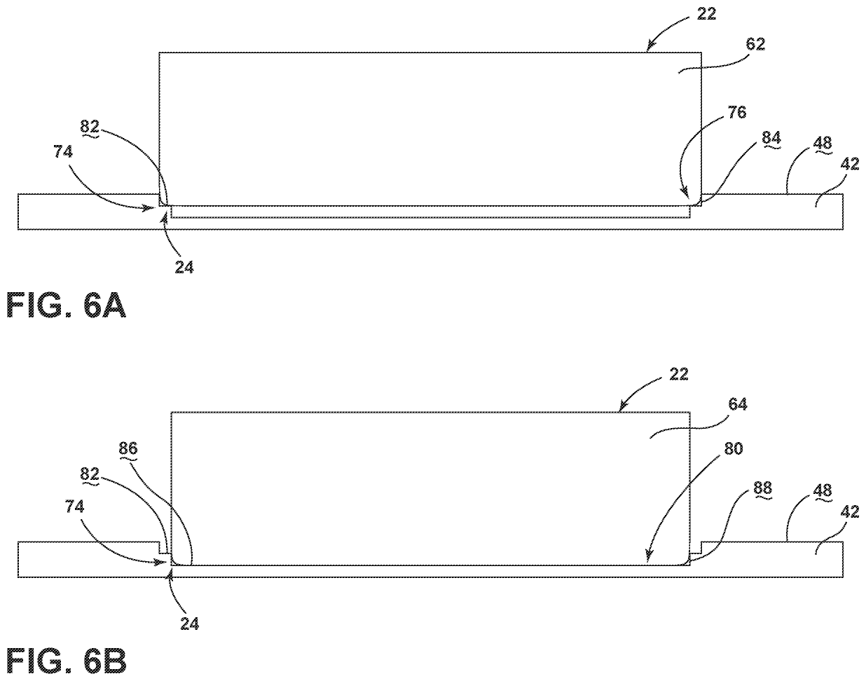

Referring to FIGS. 5-6B, the kinesthetic feature 24 in the grate 42 may provide multiple levels for supporting the cooking vessel 22 and providing feedback for the position of the cooking vessel 22. The configuration illustrated in FIGS. 5-6B provides three support levels (e.g., forming the support surface 20) for the cooking vessels 22, where the configurations in FIGS. 1-4 provide two levels (e.g., the lower face 54 and the upper face 48 forming the support surface 20). While one heating zone 18 is illustrated in FIGS. 5-6B, it is contemplated that some or all kinesthetic features 24 in grates 42 may have the multiple levels of support and feedback. Further, the multiple levels may be utilized in the grate 42 having the intersecting supports 44, as illustrated in FIG. 5, as well as the parallel supports 46 (see FIG. 4).

The heating zone 18 is identified by the surface discontinuity 23 that forms the kinesthetic feature 24 in the grate 42 and includes first steps 74 that define a first recessed area 76 and second steps 78 that define a second recessed area 80 within the first recessed area 76. The second recessed area 80 is generally smaller in size than the first recessed area 76. The first steps 74 are defined by an intermediate face 82, a first step face 84, and the upper face 48, which forms the portion of the support surface 20 of the grate 42 outside of the recessed areas 76, 80 (e.g., the surrounding surface 20e). The second steps 78 are defined by a lower face 86, a second step face 88, and the intermediate face 82. The first and second steps 74, 78 collectively define a height difference between the upper face 48 of the grate 42 and the lower face 86 of the second recessed area 80 that is substantially similar to a height difference between the lower face 54 and the upper face 48 in the configurations illustrated in FIGS. 1-4. The lower face 86, the intermediate face 82, and the upper face 48 illustrated in FIG. 5 are each part of the support surface 20 to support the cooking vessel 22. The second recessed area 80 may be a continuous and planar surface formed by the lower face 86 of the grates 42.

Referring still to FIGS. 6A and 6B, each heating zone 18 with the first and second steps 74, 78 can support cooking vessels 22 of various sizes. As illustrated in FIG. 6A, the larger cooking vessel 62 is positioned in the first recessed area 76, disposed on the intermediate faces 82. As illustrated in FIG. 6B, the smaller cooking vessel 64, which is smaller than the first cooking vessel 62, is positioned in the second recessed area 80, disposed on the lower faces 86. The user can also position a third cooking vessel, larger than each of the first and second cooking vessels 62, 64 on the upper face 48 of the grate 42, over the recessed areas 76, 80. In some cases, the larger cooking vessel 62 may rest or become tilted between the first and second recessed areas 76, 80. However, because the grates 42 extend across the heating zones 18 and the steps 74, 78, such that there is generally no break in the supports 44, 46 of the grates 42, the larger cooking vessel 62 is still restricted within the recessed areas 76, 80 and has limited movement.

The user is able to move the first cooking vessel 62 about the cooking region 16 until it is disposed in the first recessed area 76. The user is also able to move the second cooking vessel 64 about the cooking region 16 until it is disposed in the second recessed area 80. When the user is moving the cooking vessels 22 about the cooking region 16, the cooking vessels 22 may drop partially into both the first and second recessed areas 76, 80. The user would be able to determine this when the cooking vessel 22 is not substantially parallel with the support surface 20 by using the steps 74, 78 to receive kinesthetic feedback. The user may place the cooking vessel 22 in the desired first or second recessed area 76, 80, or on the upper face 48 by moving the cooking vessel 22 about the support surface 20 and lifting the cooking vessel 22 off the support surface 20. The first and second recessed areas 76, 80 are also used in a similar manner to the configurations of FIGS. 1-4.

Referring again to FIGS. 1-6B, exemplary profiles or step profiles of the steps 52, 74, 78 are illustrated where the step faces 56, 84, 88 are substantially perpendicular to the upper face 48 of the respective grate 42 and the lower face 54, 86. In the illustrated configurations, the step faces 56, 84, 88 extend about 90 degrees relative to adjacent surfaces (e.g., the lower faces 54, 86, the upper face 48, the intermediate face 82, etc.), forming sharp corners.

It is contemplated that the step faces 56, 84, 88 can define a number of different profiles. For example, the step face 56, 84, 88 may be substantially perpendicular to the upper face 48 with rounded or radiused corners where the step face 56, 84, 88 meets the upper face 48, the lower face 54, 86, and/or the intermediate face 82. In another example, the step face 56, 84, 88 may be substantially perpendicular to the upper face 48 with rounded corners where the step face 56, 84, 88 meets the upper face 48, where the step face 56, 84, 88 meets the lower face 54, 86, and/or where the step face 56, 84, 88 meets the intermediate face 82. In an additional non-limiting example, the step face 56, 84, 88 may be an “S”-curve where a center portion of the “S”-curve is not substantially perpendicular to the upper face 48. In this way, the step face 56, 84, 88 may extend at an oblique angle between the upper face 48, the intermediate face 82, and/or the lower face 54, 86 with rounded corners therebetween, forming the “S” shape.

In further aspects, the step face 56, 84, 88 may extend initially at an oblique or obtuse angle from the upper face 48 and/or the intermediate face 82 and then substantially perpendicular to the upper face 48 to the lower face 54, 86 and/or the intermediate face 82. In such examples, the transition between the oblique or obtuse angled portion of the step face 56, 84, 88 and the substantially perpendicular portion of the step face 56, 84, 88 may either be curved, rounded, or sharp. Moreover, in additional examples, the step face 56, 84, 88 may extend at an oblique or obtuse angle from the upper face 48 to the lower face 54, 86, from the upper face 48 to the intermediate face 82, and/or from the intermediate face 82 to the lower face 54, 86. It is contemplated that each cooktop assembly 10 may include one, some, or all of the step profiles described herein.

Each of the step profiles may be advantageous for different reasons. Step profiles with curved or rounded edges can provide a smooth transition from the upper face 48 to the intermediate face 82 or lower face 54, 86 and can also make cleaning the faces more efficient. Step profiles with sharp corners and/or perpendicular or non-rounded edges can provide greater kinesthetic feedback than rounded corners. A combination of the step profiles can balance the efficiency of a manufacturing process, the efficiency of cleaning, the amount of kinesthetic feedback, and the smoothness of transitions dependent on the application of the cooktop assembly 10.

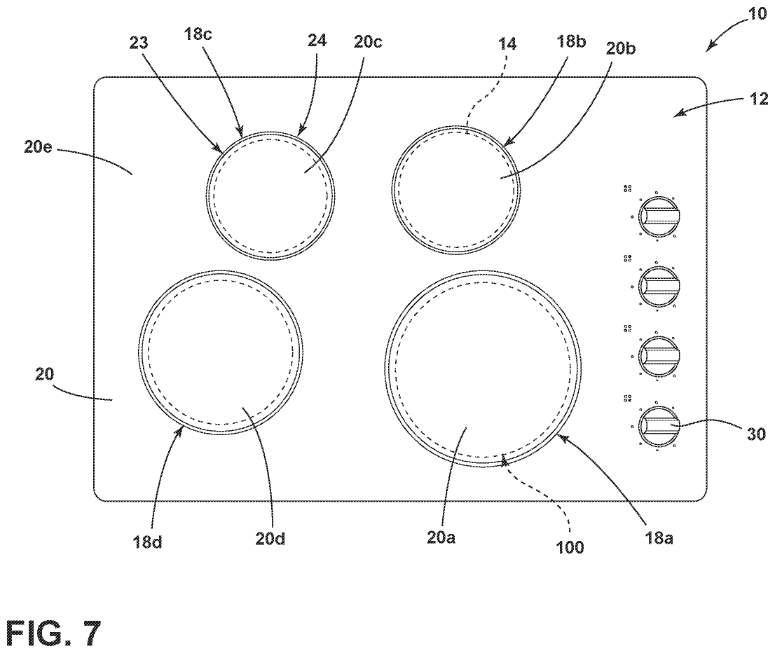

Referring to FIGS. 7-14, the cooktop assembly 10 is illustrated as an electric or radiant cooktop assembly 10 or an induction cooktop assembly 10 including the cooking panel 12 and having multiple heating zones 18. In such examples, the cooking panel 12 may be a glass panel, a ceramic panel, and/or a glass-ceramic panel. In radiant or electric cooktop assembly 10 examples, the heating elements 14 are generally configured as wire coils disposed below the cooking panel 12. When activated by a user, electricity flows to the heating elements 14 to heat the wire coils. The heat radiates through the cooking panel 12 of the cooktop assembly 10 and into the cooking vessel 22 disposed on the cooktop assembly 10.

In induction cooktop assembly 10 examples, the heating elements 14 are disposed below the cooking panel 12. The heating elements 14 generate an electromagnetic field, which causes the cooking vessel 22 disposed on the cooking panel 12 to heat. More specifically, electromagnetic energy is transferred to the cooking vessel 22 from the heating elements 14. There is no thermal energy transfer to the cooking vessel 22, but instead, there is a transfer of electromagnetic energy from the heating elements 14 which is used to heat the cooking vessel 22. The heating elements 14 in reference to electric or radiant cooktop assemblies 10 and induction cooktop assemblies 10 may be generally referred to herein as electric heating elements 100 (e.g., electric coil elements, induction heating elements), which may include electric heating elements 100a-100d.

Referring still to FIGS. 7-11, the cooking panel 12 generally defines the support surface 20 that includes the heating zone surfaces 20a-20d and the surrounding surface 20e (i.e., the non-heating zone portion of the support surface 20). As illustrated, the cooktop assembly 10 includes the heating zones 18a-18d. The heating elements 14, configured as the electric heating elements 100, are disposed under each of the heating zones 18. The heating zones 18 are defined as areas on the cooking panel 12 (e.g., the portions of the support surface 20 that form the heating zone surfaces 20a-20d) and are surrounded by the surrounding surface 20e, which is the inactive surface of the cooktop assembly 10.

One, some, or all of the heating zones 18 may be demarcated from the surrounding surface 20e by the kinesthetic feature 24 for identification and feedback. The kinesthetic feature 24 is defined by the surface disruption 23 of the cooking panel 12. Stated differently, the surface disruption 23 of the support surface 20 defines the kinesthetic features 24 for providing kinesthetic feedback for locating the heating zones 18, positioning the cooking vessels 22 relative to the heating elements 100, and centering the cooking vessels 22 with the heating elements 100. The heating zones 18 can also be demarcated from the surrounding surface 20e with serigraphy for visual identification.

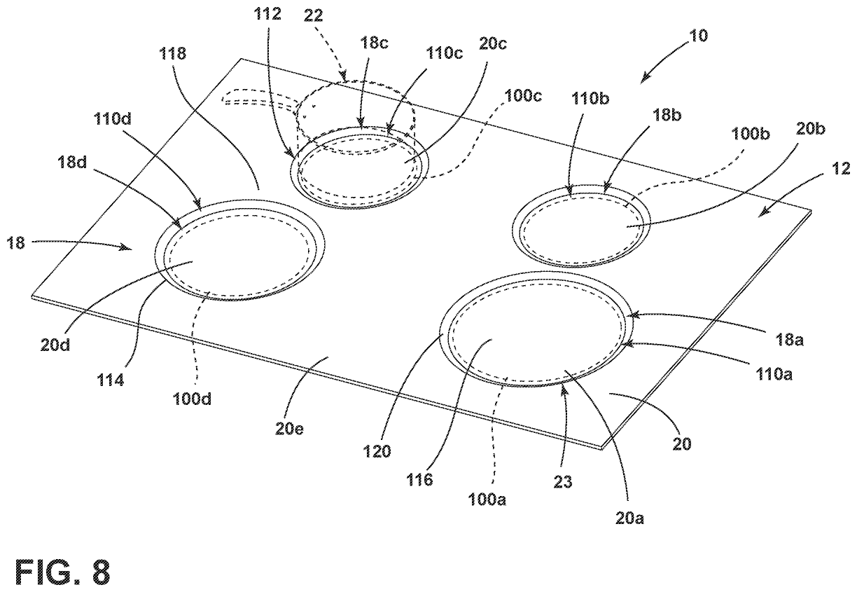

In the example illustrated in FIGS. 7 and 8, the cooking panel 12 includes the kinesthetic features 24, which define recessed areas 110 corresponding with each of the heating zones 18, respectively. As used herein, the various recessed areas 110a-110d of the multi-heating zone arrangement may collectively be referred to herein as the recessed areas 110, unless a specific one of the recessed areas 110a-110d is discussed.

Each recessed area 110 is defined by a step 112 (i.e., the surface disruption 23) in the cooking panel 12. The step 112 extends about a perimeter or circumference 114 of the respective heating zone 18. In this way, the cooking panel 12 includes a lower face 116 in each recessed area 110 (e.g., the heating zone surfaces 20a-20d), an upper face 118 (e.g., the surrounding surface 20e), and a step face 120 extending between the lower face 116 and the upper face 118. The upper face 118 generally forms the surrounding surface 20e, while the lower face 116 forms the heating zone 18. Each lower face 116 may form a continuous and planar surface for supporting the cooking vessel 22 thereon.

A size of the recessed area 110 can be varied to identify and differentiate the heating zones 18 on the cooktop assembly 10, as well as the size or strength of the corresponding heating element 100. Accordingly, the size of the recessed area 110 may be correlated to the strength or size of the electric heating element 100. For example, the heating zone 18a is illustrated as the largest recessed area 110a and may have the strongest and/or largest heating element 100a, while heating zones 18b, 18c are illustrated as the smallest recessed areas 110b, 110c and may have the weakest and/or smallest electric heating elements 100b, 100c. In the illustrated configuration, there are varied-sized recessed areas 110 for the four heating zones 18 to differentiate the heating zone 18 for the user by using the kinesthetic feature 24, providing the kinesthetic feedback.

Conventional electric and induction cooktops often rely on visual indicators to locate cooking zones. In the cooktop assemblies 10 described herein, the user is able to slide the cooking vessel 22 about the cooking region 16, and due to the kinesthetic feature 24, the user can identify the heating zones 18 and which heating zone 18 (e.g., size) based on the feedback from the kinesthetic feature 24 and/or the engagement between the cooking vessel 22 and the kinesthetic feature 24. The cooking vessel 22 is configured to drop into the recessed areas 110, providing feedback to the user. The user is also able to identify the strength or size of the heating element 14 based on the relation of the cooking vessel 22 to the steps 112, in a similar manner to that described with reference to FIGS. 3 and 4.

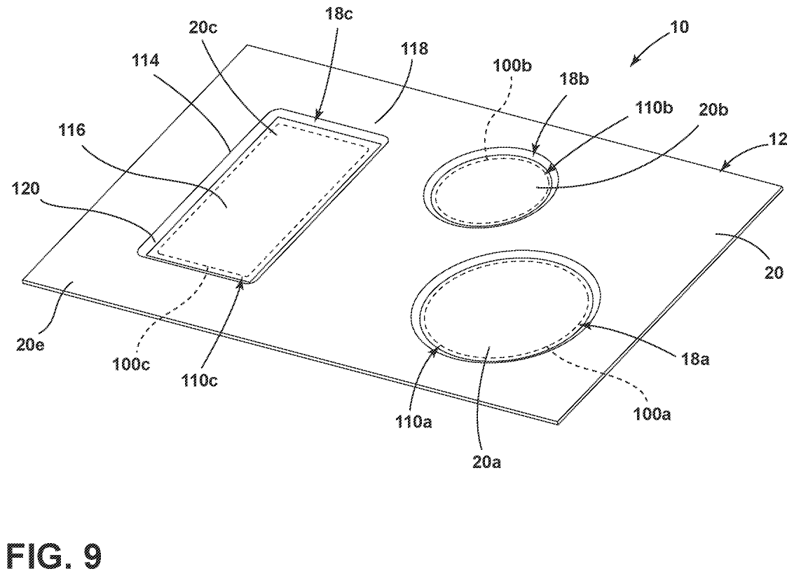

Referring to FIG. 9, the cooktop assembly 10 includes three heating zones 18a-18c. At least one electric heating element 100 is disposed under each of the heating zones 18. The cooking panel 12 includes the kinesthetic features 24 defining the recessed areas 110, similar to the configurations that are described in relation FIGS. 7 and 8. In the configuration illustrated in FIG. 9, the heating zone 18c is substantially rectangular, which may provide the user with additional options when using the cooktop assembly 10, such as using multiple cooking vessels 22 within the single heating zone 18c or for different shaped cooking vessels 22. For example, the heating zone 18c may be configured to have a gradient of heat strengths with the highest heat strength on one end of the heating zone 18c, for example the front end, and lowest heat strength at the opposite end of the heating zone 18c, for example the rear end, and/or similar functionalities as the other heating zones 18 disclosed herein. It is contemplated that shapes of the heating zone 18 are not limited to substantially circular or rectangular shapes but may be any practicable shape for supporting cooking vessels 22, cooking surfaces or utensils, and/or food items.

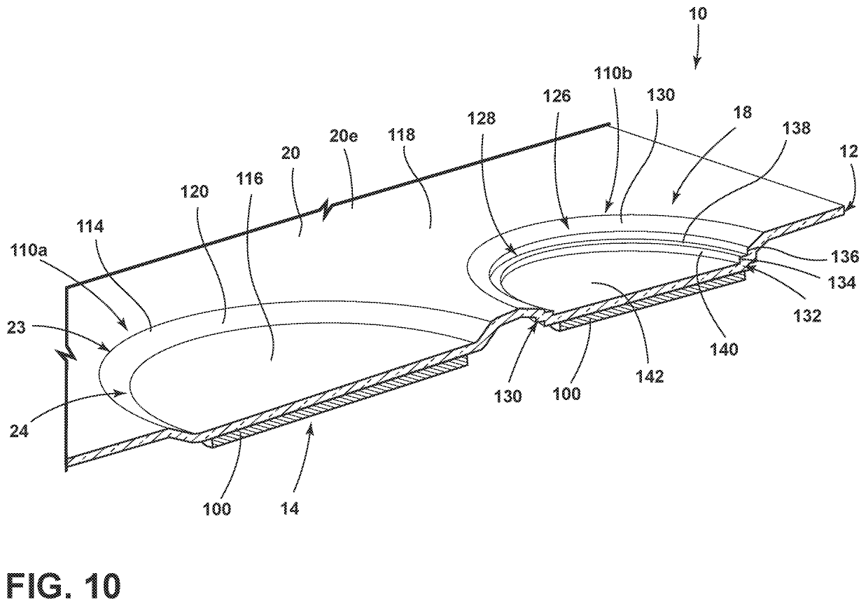

Referring to FIG. 10, the cooking panel 12 is illustrated as having two configurations of the kinesthetic feature 24. The recessed area 110a is defined by one step 112, forming two support levels for the cooking vessel 22. The step 112 is defined by the upper face 118, the step face 120, and the lower face 116. In comparison, the recessed area 110b is formed with a first recessed area 126 and a second recessed area 128, within the first recessed area 126, with a first step 130 extending the perimeter or circumference 114 of the heating zone 18 to form the first recessed area 126 and a second step 132 extending around a second perimeter or circumference 134 in the heating zone 18 to form the second recessed area 128. The first step 130 is defined by the upper face 118, a first step face 136, and an intermediate face 138. The second step 132 is defined by the intermediate face 138, a second step face 140, and the lower face 142. This configuration forms three levels for supporting the cooking vessels 22.

The first and second cooking vessels 62, 64 may be used in a similar manner with this configuration as the configuration discussed with reference to FIGS. 6A and 6B. The first cooking vessel 62 can be positioned in the first recessed area 126, and the second cooking vessel 64 can be positioned in the second recessed area 128. The third cooking vessel can also be used on the upper face 118 over the heating zone 18. The recessed areas 110a, 110b may be formed in different manners. For example, the recessed areas 110a, 110b may be created by using a press to form the recessed areas 110 into the cooking panel 12 during the manufacturing process. In this way, the recessed areas 110 are integrally defined by the cooking panel 12.

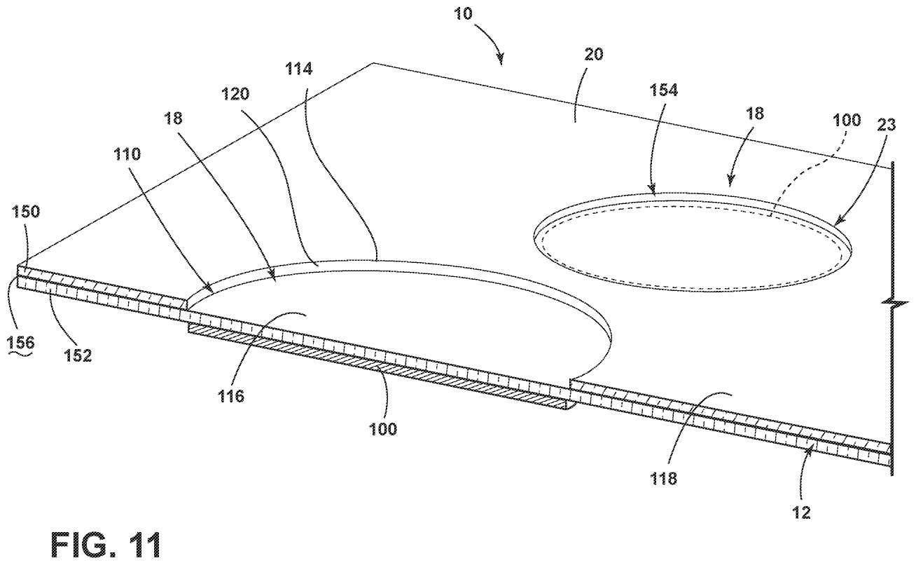

Referring to FIG. 11, in various aspects, the cooking panel 12 is formed by multiple panel layers 150, 152, such as a first panel layer 150 and a second panel layer 152, which are coupled, fused, or otherwise connected to one another to form the cooking panel 12. In such examples, the first and second panel layers 150, 152 may have different configurations to form the kinesthetic features 24 configured as the recessed areas 110. The first panel layer 150 defines cutouts 154. When the first panel layer 150 is coupled to a top surface 156 of the second panel layer 152, the cutouts 154 provide openings to expose the second panel layer 152. The first panel layer 150 forms the upper face 118, including the surrounding surface 20e and the step faces 120, and the top surface 156 of the second panel layer 154 forms the lower face 116 within the recessed area 110 (e.g., the heating zone surfaces). Further, multiple panel layers 150, 152 may be used to form the step 112 or the first and second step configurations 130, 132. The recessed areas 110 can define any of the step profiles described herein. The profiles or shapes of the recessed areas 110 can be created by using either techniques or a combination of both techniques described and can form any practicable shape or size for the heating zones 18.

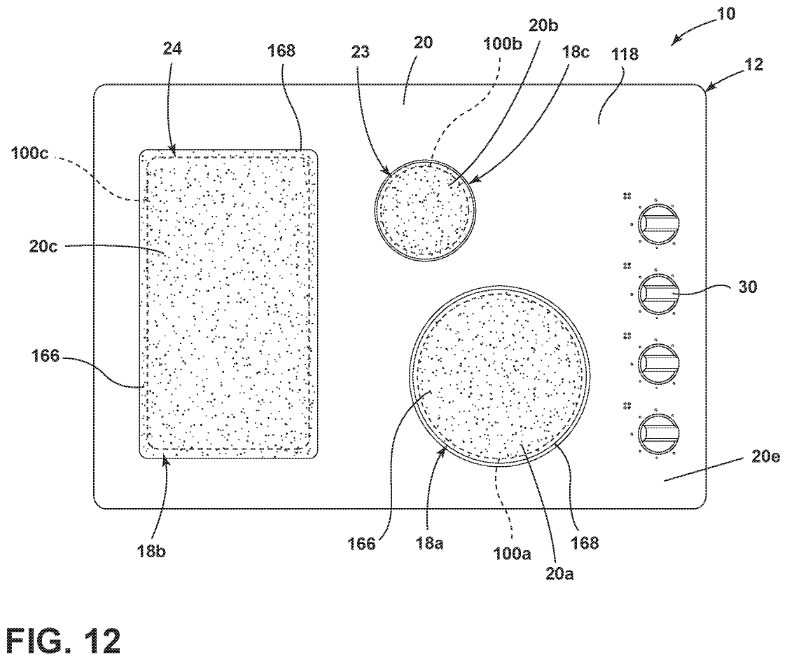

Referring to FIGS. 12-14, the cooking panel 12 may have a substantially planar and continuous upper face 118. The upper face 118 of the cooking panel 12 may define a substantially planar and continuous upper support surface 20. The support surface 20 includes the surface disruptions 23 to define the kinesthetic feature 24 for identifying the heating zones 18. The kinesthetic feature 24 is configured as a texture element 166 on the cooktop assembly 10. Generally, the texture element 166 is disposed on, or defined by, the cooking panel 12. In such examples, the heating zones 18a-18c are identified by a difference in the texture of the heating zone surfaces 20a-20c relative to the surrounding surface 20e of the cooking panel 12. The difference in texture is the surface disruption 23 defining the kinesthetic feature 24, allowing for identification of the heating zone 18 and remainder of the cooking panel 12, as well as centering of cooking vessels 22 in the heating zone 18 through audible, haptic, and/or visual feedback.

The cooktop assemblies 10 are illustrated as having serigraphy 168 to identify the heating zones 18 but the serigraphy 168 may be omitted without departing from the teachings herein. The serigraphy 168 can provide visual feedback to the user related to the location of the heating zone. The serigraphy 168 can also provide feedback during the manufacturing process on the location of heating zones 18 for the texture element 166.

Similar to other configurations described herein, the size of the heating zones 18 can correspond to the strength of the electric heating element 100 disposed under the cooking panel 12. The size or strength of the heating element 14 may generally correspond with the size of the heating element 14 or the amount of energy capable of being transferred from the electric heating element 100 to the cooking vessel 22.

Referring still to FIG. 12, the kinesthetic feature 24 is included in, such as being arranged along or defined by the heating zone surfaces 20a-20c of, the heating zones 18, such that the heating zones 18 are textured while the surrounding surface 20e is not textured. In other words, the surrounding surface 20e is smooth and free of the kinesthetic feature 24 to differentiate the surrounding surface 20e from the heating zones 18. The user is able to move the cooking vessel 22 about the cooking region 16 until the user identifies the cooking vessel 22 is engaging or sliding over the texture element 166. The user is able to identify which heating zone 18 on which the cooking vessel 22 is arranged by moving the vessel 22 about the heating zone 18. The user may also be able to gain kinesthetic feedback on whether the heating zone 18 is the optimal strength or size for the cooking vessel 22 by determining the edges of the heating zones 18 by moving the cooking vessel 22 about the heating zone 18 and comparing the area of the texture element 166 to the size of the cooking vessel 22. The feedback from the engagement between the cooking vessel 22 and the texture element 166 may be haptic, through a change in feel of the sliding movement of the cooking vessel 22, and/or audible, by a sound caused through the sliding engagement. The texture element 166 may also provide visual indication of the heating zones 18.

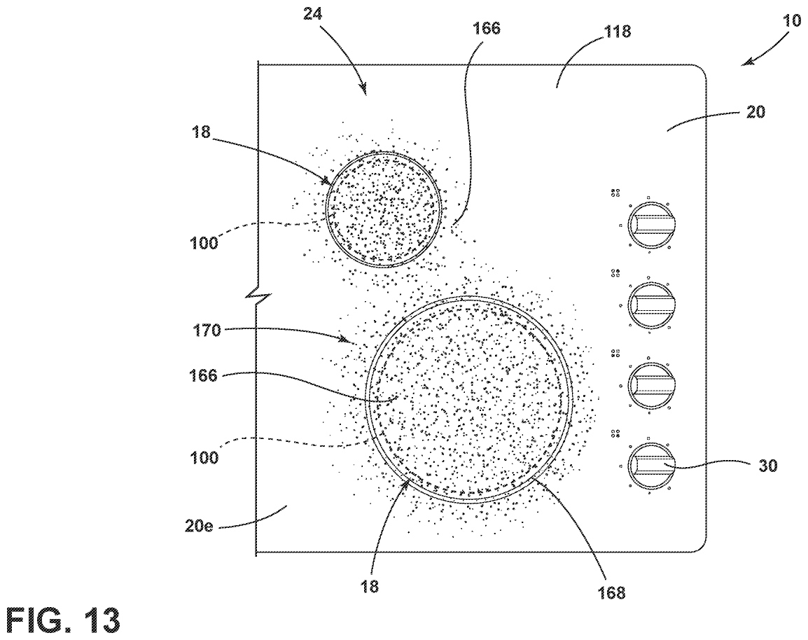

Referring to FIG. 13, similar to the configuration illustrated in FIG. 12, the kinesthetic feature 24 is configured as the texture element 166 in the heating zones 18. The surrounding surface 20e is generally smooth and substantially free of the texture element 166. The texture element 166 within each heating zone 18 defines a consistent texture density. The texture element 166 in this configuration extends outside of the heating zones 18 and around a periphery 170 of the heating zones 18.

The texture element 166 defines a gradient of the texture around the heating zone 18 on the surrounding surface 20e, where a density of the texture element 166 progressively decreases outward from the heating zone 18 until there is no texture. In other words, the density of the texture increases moving from adjacent to the heating zones 18 and into the heating zones 18, allowing feedback on the proximity of the cooking vessel 22 to the heating zones 18 when engaging the surrounding surface 20e. The user is able to move the cooking vessel 22 about the cooking region 16 until the vessel 22 engages the texture element 166 in a lower density area. Using the increase in density, the user is able to determine a direction the cooking vessel 22 is to be moved to locate the heating zone 18 and center the vessel 22 in the heating zone 18. This also provides feedback for centering the vessel 22 over the heating element 14.

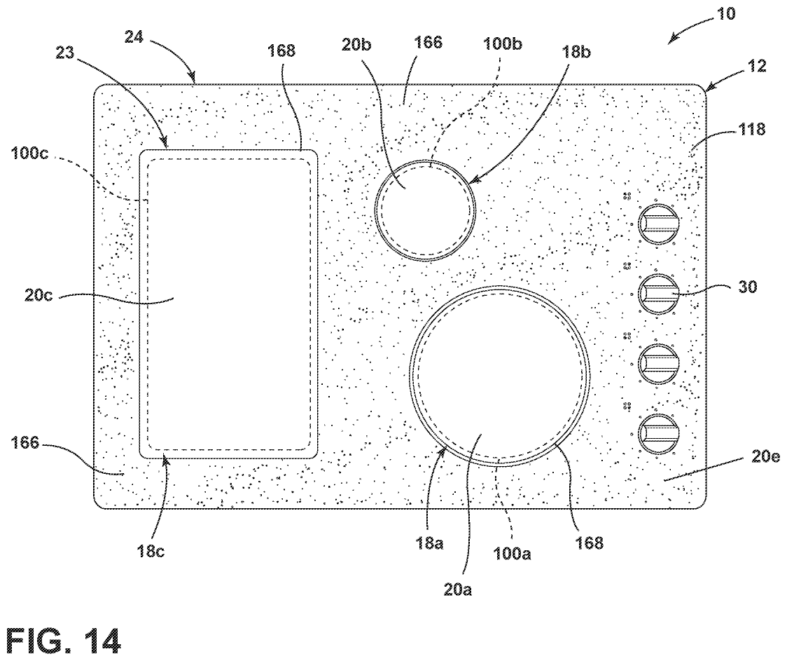

Referring to FIG. 14, the kinesthetic feature 24 is included as the texture element 166 on the surrounding surface 20e, while the heating zones 18 are free of the texture element 166. The heating zone surfaces 20a-20c are substantially smooth. The user is able to move the vessel 22 about the cooking region 16 in the same manner as discussed above. The user is able to identify the heating zones 18 by locating the substantially smooth surface on the cooking panel 12 with the cooking vessel 22 and using the texture element 166 to locate the optimal size heating zone 18 and center the vessel 22 in the heating zone 18. This configuration may also use a gradient for guiding the user toward the center of the heating zone 18, similar to the configuration in FIG. 13.

Referring again to FIGS. 12-14, the texture element 166 of the cooktop assembly 10 can be used in combination with a recessed area 110 to provide additional feedback to the user. The texture element 166 may also be used with the grates 42 (FIGS. 1-6B) without departing from the teachings herein. The kinesthetic feature 24 may also include a combination of multiple texture elements 166. In such examples, the heating zones 18 can be one texture element 166 and the surrounding surface 20e can be a second texture element 166. Different heating zones 18 may include different textures. In an additional non-limiting example, the texture may change closer to a center of the heating zone 18. The texture elements 166 can be rough, bumpy, peaks, or any other surface texture that provides kinesthetic feedback.

The texture element 166 can be formed, for example, by texturing the cooking panel 12 directly during manufacturing, such as through an embossing process. In additional or alternative examples, the texture element 166 may be coupled to or applied to the cooking panel 12, such as through a coating. The texture element 166 may be for example, adhered to the cooking panel 12, embossed into the cooking panel 12, engraved into the cooking panel 12, or any combinations thereof. It is contemplated that the texture element 166 may be a predetermined pattern, multiple patterns, irregular, combinations thereof, or other variations of surface disruptions 23.

Referring to FIGS. 1-14, the surface disruptions 23 forming the kinesthetic features 24 provide the user with haptic, audible, and/or visual feedback to the location of the heating zone 18 as well as information about the heating zone 18 (e.g., size) and corresponding heating element 14. The haptic and/or audible feedback from the kinesthetic features 24 can assist the user with locating the heating zone 18, as well as centering the cooking vessel 22 relative to the heating element 14. This may be advantageous for visually impaired users and completely blind users. The kinesthetic features 24 allow for the user to more efficiently use the cooktop assembly 10 without relying on visual indications. The kinesthetic features 24 can also assist non-visually impaired users by providing additional visual feedback along with the haptic and/or audible feedback. Moreover, the kinesthetic features 24 do not limit the type or size of cooking vessels 22 used with the cooktop assembly 10. Multiple sizes of vessels 22 may be used with each size and configuration of heating zone 18 described herein.

Use of the presently disclosed device may provide a variety of advantages. For example, the kinesthetic feature 24 can provide feedback to the visually impaired user on the location of the cooking vessel 22. Also, this feedback may be haptic and/or audible. Moreover, the kinesthetic features 24 can help guide blind, visually impaired, or non-visually impaired users to optimal heating zones 18. For example, the heating zones 18 in the multi-heating zone arrangement are configured such that the relative size of the heating zones 18 corresponds to the relative strength of the heating elements 14. Further, the kinesthetic features 24 can provide visual feedback to the non-visually impaired user on the optimal locations to position the cooking vessel 22 in the heating zone 18. Additionally, the kinesthetic features 24 can assist the visually impaired user with positioning the cooking vessel 22 in an optimal or centralized position in the heating zone 18 for aligning the cooking vessel 22 with the heating element 14. Additional benefits or advantages of using this device may also be realized and/or achieved.

The device disclosed herein is further summarized in the following paragraphs and is further characterized by combinations of any and all of the various aspects described herein.

According to an aspect of the present disclosure, a cooktop assembly includes a cooking panel. A heating element is operably coupled to the cooking panel. The heating element forms a heating zone for said cooktop assembly. A support surface extends over the heating element for supporting a cooking vessel thereon. The support surface includes a heating zone surface in the heating zone, a surrounding surface outside the heating zone, and a surface discontinuity defining a kinesthetic feature providing feedback for demarcating the heating zone relative to the surrounding surface and positioning the cooking vessel relative to the heating zone and, consequently, the heating element.

According to another aspect, a grate positioned on a cooking panel and defining the support surface. A kinesthetic feature is a recessed area defined by the grate. A heating element is a gas burner.

According to yet another aspect, a heating zone surface is a single continuous surface.

According to another aspect, a heating element is at least one of an induction heating element and an electric coil element. A cooking panel defines a support surface and a cooking vessel is configured to be positioned on the cooking panel when positioned over the heating zone.

According to yet another aspect, a kinesthetic feature is a recessed area defined by a cooking panel.

According to another aspect, a kinesthetic feature is a texture element defined by a cooking panel within a heating zone.

According to yet another aspect, a kinesthetic feature is a texture element defined by a cooking panel outside of a heating zone.

According to another aspect of the present disclosure, a cooktop assembly includes a cooking panel, heating elements operably coupled to the cooking panel to define heating zones for the cooktop assembly, and a support surface extending over the heating elements and configured to support cooking vessels thereon. The support surface includes heating zone surfaces aligned with the heating elements and a surrounding surface. The support surface defines a first surface disruption forming a first recessed surface relative to the surrounding surface, the first recessed surface being defined over a first one of the heating elements to provide kinesthetic feedback for a location of a first one of the heating zones to align the cooking vessels with the first one of the heating elements. The support surface defines a second surface disruption forming a second recessed surface relative to the surrounding surface, the second recessed surface being defined over a second one of the heating elements to provide kinesthetic feedback for a location of a second one of the heating zones to align the cooking vessels with the second one of the heating elements.

According to another aspect, a first surface disruption is a single step between a first recessed surface and a surrounding surface. A second surface disruption is a single step between a second recessed surface and a surrounding surface.

According to yet another aspect, a first recessed surface is a single continuous surface and a second recessed surface is a single continuous surface.

According to another aspect, heating elements are electric heating elements. A cooking panel defines a support surface, a first surface disruption, and a second surface disruption.

According to yet another aspect, heating elements are gas burners. At least one grate having intersecting supports is positioned on a cooking panel and defines a support surface, a first surface disruption, and a second surface disruption.

According to another aspect, heating elements are gas burners. At least one grate having parallel supports is positioned on a cooking panel and defines a support surface, a first surface disruption, and a second surface disruption.

According to yet another aspect, a first recessed surface is larger than a second recessed surface. A first one of a heating elements is larger than a second one of a heating elements.

According to yet another aspect of the present disclosure, a cooktop assembly includes a cooking panel including an upper support surface, the upper support surface including heating zone surfaces and a surrounding surface, and a texture element arranged along the upper support surface. The cooktop assembly includes electric heating elements operably coupled to the cooking panel and aligned with the heating zone surfaces to define heating zones for the cooktop assembly, the heating zones including at least one demarcated heating zone. The texture element defines at least one surface discontinuity providing kinesthetic feedback for demarcating the at least one demarcated heating zone relative to the surrounding surface.

According to another aspect, a texture element is arranged on a heating zone surface of an at least one demarcated heating zone.

According to yet another aspect, a texture element is arranged on the surrounding surface outside of a heating zone surface of an at least one demarcated heating zone.

According to another aspect, a texture element is included on a heating zone surface of an at least one of demarcated heating zone and included on a surrounding surface along a periphery of the at least one demarcated heating zone. A density of the texture element progressively decreases as the texture element extends from the periphery of the at least one demarcated heating zone.

According to yet another aspect, at least one surface discontinuity includes a first surface discontinuity and a second surface discontinuity. An at least one demarcated heating zone includes a first demarcated heating zone and a second demarcated heating zone. The first surface discontinuity demarcates the first demarcated heating zone from a surrounding surface and the second surface discontinuity demarcates the second demarcated heating zone from the surrounding surface.

According to another aspect, a texture element is included on a heating zone surface of each of a first demarcated heating zone defining a first surface discontinuity and on a heating zone surface of a second demarcated heating zone heating zone defining a second surface discontinuity.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooktop assembly, comprising:
a cooking panel;
a heating element operably coupled to the cooking panel, wherein the heating element forms a heating zone for said cooktop assembly; and
a support surface extending over the heating element for supporting a cooking vessel thereon, wherein the support surface includes:
a heating zone surface in the heating zone;
a surrounding surface outside the heating zone; and
a surface discontinuity defining a kinesthetic feature providing feedback for demarcating the heating zone surface relative to the surrounding surface and positioning the cooking vessel relative to the heating zone and, consequently, the heating element.

2. The cooktop assembly of claim 1, further comprising:
a grate positioned on the cooking panel and defining the support surface, wherein the kinesthetic feature is a recessed area defined by the grate, wherein the heating element is a gas burner.

3. The cooktop assembly of claim 2, wherein the heating zone surface is a single continuous surface.

4. The cooktop assembly of claim 1, wherein the heating element is at least one of an induction heating element and an electric coil element, and wherein the cooking panel defines the support surface and the cooking vessel is configured to be positioned on the cooking panel when positioned over the heating zone.

5. The cooktop assembly of claim 4, wherein the kinesthetic feature is a recessed area defined by the cooking panel.

6. The cooktop assembly of claim 4, wherein the kinesthetic feature is a texture element defined by the cooking panel within the heating zone.

7. The cooktop assembly of claim 4, wherein the kinesthetic feature is a texture element defined by the cooking panel outside of the heating zone.

8. A cooktop assembly, comprising:
a cooking panel;
heating elements operably coupled to the cooking panel to define heating zones for said cooktop assembly; and
a support surface extending over the heating elements and configured to support cooking vessels thereon, the support surface including heating zone surfaces aligned with the heating elements and a surrounding surface, wherein the support surface defines:
a first surface disruption forming a first recessed surface relative to the surrounding surface, the first recessed surface being defined over a first one of the heating elements to provide kinesthetic feedback for a location of a first one of the heating zones to align the cooking vessels with the first one of the heating elements; and
a second surface disruption forming a second recessed surface relative to the surrounding surface, the second recessed surface being defined over a second one of the heating elements to provide kinesthetic feedback for a location of a second one of the heating zones to align the cooking vessels with the second one of the heating elements.

9. The cooktop assembly of claim 8, wherein the first surface disruption is a single step between the first recessed surface and the surrounding surface, and wherein the second surface disruption is a single step defined between the second recessed surface and the support surface.

10. The cooktop assembly of claim 8, wherein the first recessed surface is a single continuous surface, and wherein the second recessed surface is a single continuous surface.

11. The cooktop assembly of claim 10, wherein the heating elements are electric heating elements, and wherein the cooking panel defines the support surface, the first surface disruption, and the second surface disruption.

12. The cooktop assembly of claim 10, wherein the heating elements are gas burners, and wherein at least one grate having intersecting supports is positioned on the cooking panel and defines the support surface, the first surface disruption, and the second surface disruption.

13. The cooktop assembly of claim 8, wherein the heating elements are gas burners, and wherein at least one grate having parallel supports is positioned on the cooking panel and defines the support surface, the first surface disruption, and the second surface disruption.

14. The cooktop assembly of claim 8, wherein the first recessed surface is larger than the second recessed surface, and wherein the first one of the heating elements is larger than the second one of the heating elements.

15. A cooktop assembly, comprising:
a cooking panel including:
an upper support surface, the upper support surface including heating zone surfaces and a surrounding surface; and
a texture element arranged along the upper support surface; and
electric heating elements operably coupled to the cooking panel and aligned with the heating zone surfaces to define heating zones for said cooktop assembly, the heating zones including at least one demarcated heating zone, wherein the texture element defines at least one surface discontinuity providing kinesthetic feedback for demarcating the at least one demarcated heating zone relative to the surrounding surface.

16. The cooktop assembly of claim 15, wherein the texture element is arranged on the heating zone surface of the at least one demarcated heating zone.

17. The cooktop assembly of claim 15, wherein the texture element is arranged on the surrounding surface outside of the heating zone surface of the at least one demarcated heating zone.

18. The cooktop assembly of claim 15, wherein the texture element is included on the heating zone surface of the at least one of demarcated heating zone and included on the surrounding surface along a periphery of the at least one demarcated heating zone, and wherein a density of the texture element progressively decreases as the texture element extends from the periphery of the at least one demarcated heating zone.

19. The cooktop assembly of claim 15, wherein the at least one surface discontinuity includes a first surface discontinuity and a second surface discontinuity, and wherein the at least one demarcated heating zone includes a first demarcated heating zone and a second demarcated heating zone, the first surface discontinuity demarcating the first demarcated heating zone from the surrounding surface and the second surface discontinuity demarcating the second of demarcated heating zone from the surrounding surface of the cooking panel.

20. The cooktop assembly of claim 19, wherein the texture element is included on the heating zone surface of each of the first demarcated heating zone defining the first surface discontinuity and on the heating zone surface of the second demarcated heating zone defining the second surface discontinuity.
